(19) United States
(12) Patent Application Publication
(10) Pub. No.: US 2014/0149320 A1
(43) Pub. Date: May 29, 2014

(54) CONSISTENT PRICE OPTIMIZATION IN TRANSPORTATION NETWORKS

(71) Applicant: INTERNATIONAL BUSINESS MACHINES CORPORATION, Armonk, NY (US)

(72) Inventors: Marco Laumanns, Zurich (CH); Olivier Gallay, Zurich (CH); Jácint Szabó, Adliswil (CH); Ban Hashem Khalil Kawas, Yorktown Heights, NY (US); Stefan Wörner, Zurich (CH); Jürgen Koehl, Schaffhausen (CH)

(73) Assignee: INTERNATIONAL BUSINESS MACHINES CORPORATION, Armonk, NY (US)

(21) Appl. No.: 13/688,254

(22) Filed: Nov. 29, 2012

(51) Int. Cl. G06Q 30/02; G06Q 50/30

(52) U.S. Cl. CPC G06Q 30/0283; G06Q 50/30
USPC 705/400

(57) ABSTRACT

A system and method is provided for consistent price optimization in multi-modal transportation networks. A corridor is constructed for each origin-destination pair of a transportation network based on one or more parameters. Monotonicity constraints and triangle constraints are generated for each origin-destination pair. An objective function is constructed and convexified using point-price elasticity for consistent price optimization. The one or more parameters and coefficients for a mathematical optimization program are then computed and the mathematical optimization problem is solved for a consistent optimal pricing scheme.

### BACKGROUND

The present invention relates to price optimization, and more specifically, to providing consistent price optimization in transportation networks.

Pricing and revenue management is of central and increasing importance in the travel and transportation (T&T) industry. Pricing and revenue management is typically one of the most strategic and powerful ways T&T companies can improve their business and financial performance. From a marketing perspective, it has a long-lasting and deep impact on the passengers' satisfaction and trust in the company. In addition, pricing is a powerful tool in capacity management and load balancing. The economic downturn has forced transportation companies to proactively reevaluate their pricing practices to reclaim margins without putting revenue at risk. Accordingly, the global T&T industry is moving from single-mode static pricing models to a new demand for an integrated fare management, with a multi-modal, relational pricing intelligence at its core. The integrated fare management is based on an automated, data-driven scientific approach to optimize its pricing scheme.

### SUMMARY

According to an embodiment, a computer-implemented method is provided for consistent price optimization in multi-modal transportation networks. A corridor is constructed, with a processing device, for each origin-destination pair of a transportation network based on one or more parameters. Monotonicity constraints and triangle constraints are generated for each origin-destination pair. An objective function is constructed and convexified using point-price elasticity for consistent price optimization. The one or more parameters and coefficients for a mathematical optimization program are then computed and the mathematical optimization problem is solved for a consistent optimal pricing scheme.

According to another embodiment, a computer system, including a processor, a system memory, and a bus, is configured to perform a method for consistent price optimization in multi-modal transportation networks. A corridor is constructed, with a processing device, for each origin-destination pair of a transportation network based on one or more parameters. Monotonicity constraints and triangle constraints are generated for each origin-destination pair. An objective function is constructed and convexified using point-price elasticity for consistent price optimization. The one or more parameters and coefficients for a mathematical optimization program are then computed and the mathematical optimization problem is solved for a consistent optimal pricing scheme.

According to another embodiment, a computer program product comprising a computer readable storage medium having computer readable program code stored thereon that executes a method for consistent price optimization in multi-modal transportation networks. A corridor is constructed, with a processing device, for each origin-destination pair of a transportation network based on one or more parameters. Monotonicity constraints and triangle constraints are generated for each origin-destination pair. An objective function is constructed and convexified using point-price elasticity for consistent price optimization. The one or more parameters and coefficients for a mathematical optimization program are then computed and the mathematical optimization problem is solved for a consistent optimal pricing scheme.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a computer system according to an embodiment;

FIG. 2 depicts a system architecture for consistent price optimization in transportation networks according to an embodiment;

FIG. 3 depicts diagrammatic representation of a constructed corridor for an origin-destination pair according to embodiment; and

FIG. 4 depicts a flow diagram of an operation for consistent price optimization in transportation networks according to an embodiment.

### DETAILED DESCRIPTION

Embodiments disclosed herein provide an exemplary system and method for consistent price optimization in multi-modal transportation networks. A corridor is constructed for each origin-destination pair of a transportation network based on one or more parameters. Monotonicity constraints and triangle constraints are generated for each origin-destination pair. An objective function is constructed and convexified using point-price elasticity. The one or more parameters and coefficients for the objective function are then computed. The constraints and the objective function are combined into a mathematical optimization program for consistent price optimization. The mathematical optimization program is solved to obtain a consistent optimal pricing scheme.

The global transportation industry is moving from single-mode static pricing models to multi-modal pricing intelligence demands. However, seamless and smarter transportation and multi-modal mobility pricing concepts cannot be implemented if corresponding pricing engines are not available to support such a demand. In particular, the simultaneous management of thousands of different price elements, fare rules, transport service components and constraints together with the coordination of local and long-distance transport service networks is a complex problem with no existing industry solution. Contemporary revenue and yield management solutions in the transportation industry, which are mainly developed for airlines and a few long-distance railways, ignore the consistency and feasibility aspect that arises in the price management of next-generation transportation networks.

In contemporary industrial practice there are several options for implementing a pricing scheme. A basic approach, adapted mostly in the railway and coach segments, is distance-based pricing, where the fare between an origin-destination (O-D) pair is based on the distance covered. A more advanced pricing scheme is direct connection pricing, where the fare for every individual O-D pair is set independently, in order to maximize revenue on the particular connection, taking into respect other political and business constraints. To be able to estimate revenue, good approximation is needed to the passengers' reaction to the change of fares, whose quantified value is called price elasticity.

In practice, direct connection pricing is usually executed for every O-D pair independently. However, this approach may lead to inconsistent pricing schemes, giving rise to negative consequences such as triangle and monotonicity inconsistencies. Triangle inconsistency arises when the fare for traveling between origin O to destination D is more expensive than the fare between O and a third station V, plus the fare between V and D. In this case, it is worth for the passenger to buy two tickets, one from O to V, and one from V to D. The two corridors from O to V and from V to D contain all nodes of the corridor from O to D, then it is not less convenient for the passenger to take this ticket choice. Monotonicity inconsistency arises when (1) D is in the corridor of O and a third station V, making it possible to travel from O to V via D, and (2) the fare from origin O is cheaper to V than to D. In this case the pricing scheme can be abused by “overshooting,” that is, buying a ticket from O to V and then getting off at destination D.

Both inconsistencies make abuse of the pricing system possible, leading to system deformations, and to numerous undesired consequences. These consequences include more difficult revenue forecasting and capacity management. Moreover, if publicized or revealed in some way, it may diminish trust in the company, have a bad impact on its reputation, and make passengers feel uncomfortable. Accordingly, existing contemporary tools are not able to properly address the problem of large-scale integrated fare management and automatic fare optimization for large multi-modal public transportation systems.

Embodiments of the disclosure provide a solution for the multi-modal pricing intelligence demand based on large-scale convex optimization techniques by combining optimization-based revenue and yield management with maintenance of the complex consistency of highly-interrelated prices over a large, multi-modal transportation network. Embodiments provide the feasibility and consistency of all prices with respect to business-related requirements and constraints. Moreover, embodiments optimize the prices within a complex set of constraints regarding user-specified criteria, such as revenue maximization based on estimated price elasticities, price-demand functions and willingness-to-pay. Embodiments further provide significant financial gain for transportation system operators, while developing future smarter multi-modal public transportation systems.

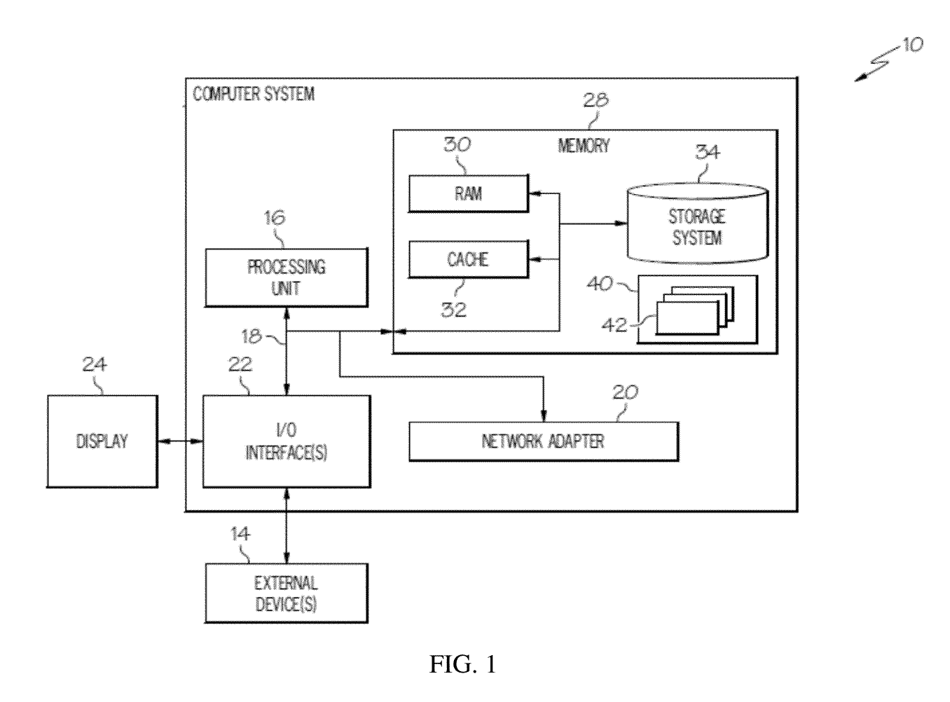

Referring now to FIG. 1, a block diagram of a computer system 10 suitable for providing consistent price optimization in transportation networks according to exemplary embodiments is shown. Computer system 10 is only one example of a computer system and is not intended to suggest any limitation as to the scope of use or functionality of embodiments described herein. Regardless, computer system 10 is capable of being implemented and/or performing any of the functionality set forth hereinabove.

Computer system 10 is operational with numerous other general purpose or special purpose computing system environments or configurations. Examples of well-known computing systems, environments, and/or configurations that may be suitable for use with computer system 10 include, but are not limited to, personal computer systems, server computer systems, thin clients, thick clients, cellular telephones, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 10 may be described in the general context of computer system-executable instructions, such as program modules, being executed by the computer system 10. Generally, program modules may include routines, programs, objects, components, logic, data structures, and so on that perform particular tasks or implement particular abstract data types. Computer system 10 may be practiced in distributed cloud computing environments where tasks are performed by remote processing devices that are linked through a communications network. In a distributed computing environment, program modules may be located in both local and remote computer system storage media including memory storage devices.

As shown in FIG. 1, computer system 10 is shown in the form of a general-purpose computing device. The components of computer system may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 10 may include a variety of computer system readable media. Such media may be any available media that is accessible by computer system/server 10, and it includes both volatile and non-volatile media, removable and non-removable media.

System memory 28 can include computer system readable media in the form of volatile memory, such as random access memory (RAM) 30 and/or cache memory 32. Computer system 10 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 10 may also communicate with one or more external devices 14 such as a keyboard, a pointing device, a display 24, etc.; one or more devices that enable a user to interact with computer system/server 10; and/or any devices (e.g., network card, modem, etc.) that enable computer system/server 10 to communicate with one or more other computing devices. Such communication can occur via Input/Output (I/O) interfaces 22. Still yet, computer system 10 can communicate with one or more networks such as a local area network (LAN), a general wide area network (WAN), and/or a public network (e.g., the Internet) via network adapter 20. As depicted, network adapter 20 communicates with the other components of computer system 10 via bus 18. It should be understood that although not shown, other hardware and/or software components could be used in conjunction with computer system 10. Examples include, but are not limited to: microcode, device drivers, redundant processing units, external disk drive arrays, RAID systems, tape drives, and data archival storage systems, etc.

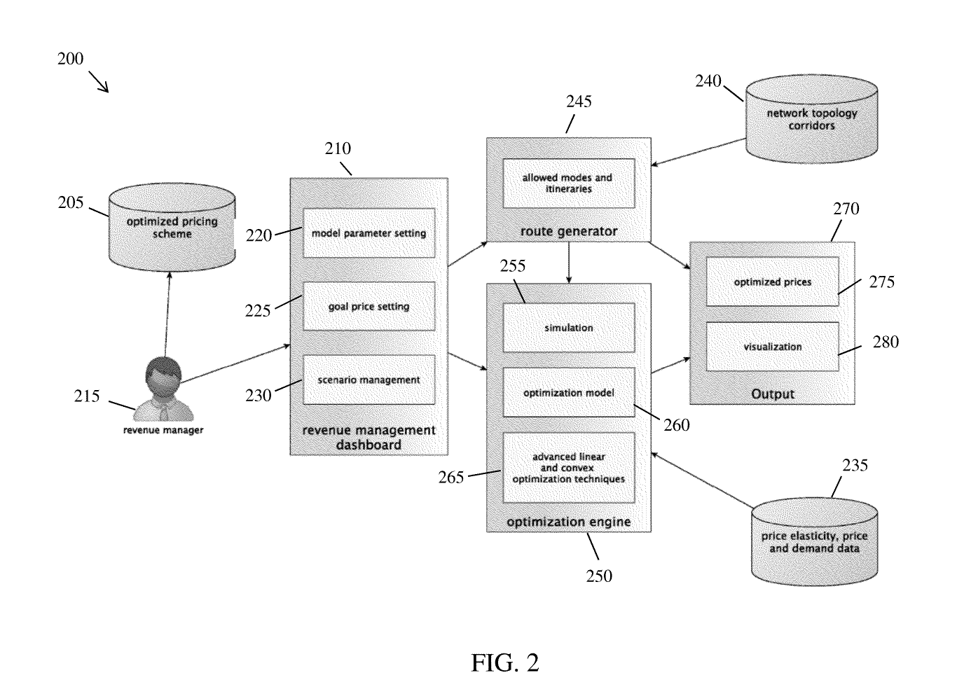

With reference now to FIG. 2, a system architecture 200 for consistent price optimization in transportation networks of an embodiment is shown. The system architecture 200 may be implemented by processing unit 16 of computer system 10, as shown in FIG. 1. An embodiment provides an automated and interactive decision support tool to efficiently optimize, simulate, and visualize consistent pricing schemes, together with an interactive dashboard for scenario management, what-if analysis, and control of the revenue management process. Specifically, an embodiment provides an optimized pricing scheme 205 for a transportation network.

A revenue management dashboard 210 is the primary interface of an embodiment that may be used by a revenue manager 215. The revenue management dashboard 210 comprises a model parameter input module 220, a goal price setting module 225, and a scenario management module 230. The model parameter input module 220 allows the revenue manager 215 to influence an optimized pricing scheme by inputting numerically specified business parameters, such as an allowed monotone detour limit and an allowed betweenness limit, which are discussed further below. The goal price setting module 225 accepts a target price input value from the revenue manager 215. The target price input value is analyzed to find consistent pricing schemes with prices that match the target price as closely as possible. The scenario management module 230 allows the revenue manager 215 to manage various scenarios, differing in business parameters, goal prices, other predefined prices, underlying transportation networks, and modes of transport.

A price elasticity, price and demand database 235 comprises all available and statistically verified data on the price elasticities of passengers, together with the current price system and the observed demand. A network topology and corridor database 240 comprises a transportation network in a high, aggregated level, and the corridors allowed by business rules between all O-D pairs.

A route generator module 245 determines allowed modes and itineraries, while taking the business parameters into account. For example, although the allowed corridors are predefined in the network topology and corridors database 240 with monotone detour limit parameters, which are described further below, it is possible to require monotonicity consistency for an alternative corridor.

In an optimization engine 250, a simulation module 255 estimates the revenue if a pricing scheme is deployed, and in case of inconsistency, the result of pricing abuse. An optimization model module 260 uses advanced linear and convex optimization techniques 265 to calculate a consistent pricing scheme yielding the highest possible revenue under given input data. The input data used to calculate the consistent pricing scheme yielding the highest possible revenue of an embodiment is as follows.
A transportation network consisting of a set N of stations and a set A of direct connections between them from the network topology and corridors database 240.
Current price Pᵢⱼ^{curr} and current demand dᵢⱼ^{curr} for every O-D pair i,jεN from the price elasticity, price and demand database 235.
Price elasticity function ƒᵢⱼ for every O-D pair i,jεN from the price elasticity, price and demand database 235, giving an approximation fᵢⱼ (p) to the demand if a new fare is set to p. An embodiment assumes that fᵢⱼ is linear with slope−e_{ij p}^{d} and fᵢⱼ(p)=d, where p is the current price and d is the current demand. Accordingly, a 1% increase in price leads to −eᵢⱼ% decrease in demand.
Goal price Pᵢⱼ^{goal} and maximum allowed price variation Δᵢⱼ^{goal} for every O-D pair i,jεN, specified in the goal price setting module 225. For simplicity, an embodiment assumes the goal price is the current price.
Detour ratio detourᵢⱼ^{k} for every O-D pair i,jεN and third station kεN, which is the ratio of the shortest path from station i to j via station k, and the shortest path between i and j. This detour ratio data is contained in the network topology and corridors database 240.
Betweenness ratio betweenᵢⱼ^{k} for every O-D pair i,jεN and third station kεN, which is the ratio of the maximum of the shortest paths from stations i to k and that from k to j, and the shortest path from i to j. For example, if the third station is equidistant to i and j, then the betweenness ratio would be 50%. The betweenness ratio data is contained in the network topology and corridors database 240.

As discussed above, the model parameter input module 220 allows the revenue manager 215 to influence an optimized pricing scheme by inputting numerically specified business parameters. The parameters specified in the model parameter setting module comprise the allowed monotone detour limit Δᵢⱼ^{monotone}, and the allowed betweenness limit Δᵢⱼ^{between} for every O-D pair i,jεN.

Decision variables in the mathematical optimization problem are the price variables Pᵢⱼ^{new}≧0 for every O-D pair i,jεN. When considering linear price elasticity, we have:

$${D}_{ij}^{new} = ( 1 - {e}_{ij} ) {D}_{ij}^{curr} + \frac{{e}_{ij} {D}_{ij}^{curr}}{{P}_{ij}^{curr}} {P}_{ij}^{new} , \\ ∀ i , j ∈ N , i < j .$$

The global revenue is hence given by:

$${R}^{new} \begin{matrix}= R ( {\vec{P}}^{new} , {\vec{D}}^{new} ) \\ = {\sum }_{i , j ∈ 𝒩 , i < j}^{ } {P}_{ij}^{new} {D}_{ij}^{new} \\ = {\sum }_{i , j ∈ 𝒩 , i < j}^{ } ( 1 - {e}_{ij} ) {D}_{ij}^{curr} {P}_{ij}^{new} + \frac{{e}_{ij} {D}_{ij}^{curr}}{{P}_{ij}^{curr}} {( {P}_{ij}^{new} )}^{2}\end{matrix}$$

The mathematical optimization problem is as follows. The objective is

max_{P}_{ᵢⱼ}^{new}R^{new},

that is to maximize the global revenue.

Optionally, according to other embodiments, other objectives can be set for the mathematical optimization problem. For example, other objectives may comprise finding a consistent pricing scheme minimizing the sum of the deviations to goal prices, or the sum of the squares of the deviations between the optimized and the goal price, or minimizing the number of O-D pairs where it differs from the goal price.

The constraints in the mathematical optimization problem of an embodiment comprise consistency constraints, such as triangle constraints and monotonicity constraints, and price variation constraints.

The triangle constraint of an embodiment may be defined such that for each O-D pair i,jεN and third station kεN, k≠i,j,

Pᵢⱼ^{new}≦Pᵢₖ^{new}+Pₖⱼ^{new}.

The monotonicity constraint of an embodiment may be defined such that for each O-D pair i,jεN, and third station kεN, k≠i,j,

If detourᵢⱼ^{k}≦Δᵢⱼ^{monotone} and betweenᵢⱼ^{k}≦Δᵢⱼ^{between}:Pᵢⱼ^{new}≧Pᵢₖ^{new}.

If detourᵢⱼ^{k}≦Δᵢⱼ^{monotone} and betweenᵢⱼ^{k}≦Δᵢⱼ^{between}:Pᵢⱼ^{new}≧Pᵢₖ^{new}.

The price variation constraint of an embodiment may be defined such that for each O-D pair i,jεN,

Pᵢⱼ^{new}≦(1+Δᵢⱼ^{curr})Pᵢⱼ^{curr}.

Pᵢⱼ^{new}≧(1−Δᵢⱼ^{curr})Pᵢⱼ^{curr}.

The output module 270 of an embodiment displays optimized prices 275 for a transportation network according to the mathematical optimization problem in view of the objective function, the parameters, and the constraints set by the revenue manager 215. In the visualization module 280 the revenue manager 215 may navigate through thousands of relational prices and analyze the effects of different constraints and assumptions.

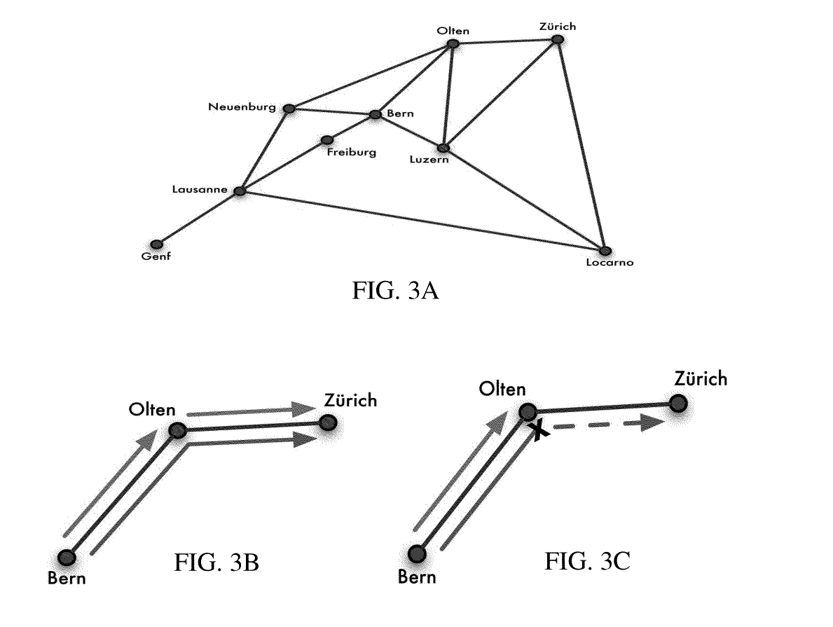

Referring FIG. 3A, a constructed corridor 300 of an embodiment is shown. The constructed corridor 300 is an allowed set of nodes on a feasible O-D path. Examples of feasible O-D paths include paths from Genf to Lausanne, Genf to Freiburg via Lausanne, Genf to Olten via Lausanne, Freiburg, Bern, and Neuenburg, and Genf to Locarno via Lausanne, Freiburg, Bern, Neuenburg, Olten, Luzern, and Zürich.

For every O-D pair and every corridor node, an embodiment comprises the two network topology consistency constraints discussed above. FIG. 3B shows an example of the triangle constraint according to an embodiment. The triangle constraint is defined such that the price of a trip from Bern to Zürich must be less than or equal to the price of the trip from Bern to Olten plus the price of the trip from Olten to Zürich. FIG. 3C shows an example of the monotonicity constraint according to an embodiment. The monotonicity constraint is defined such that price of the trip from Bern to Zürich must be greater than or equal to the price of the trip from Bern to Olten.

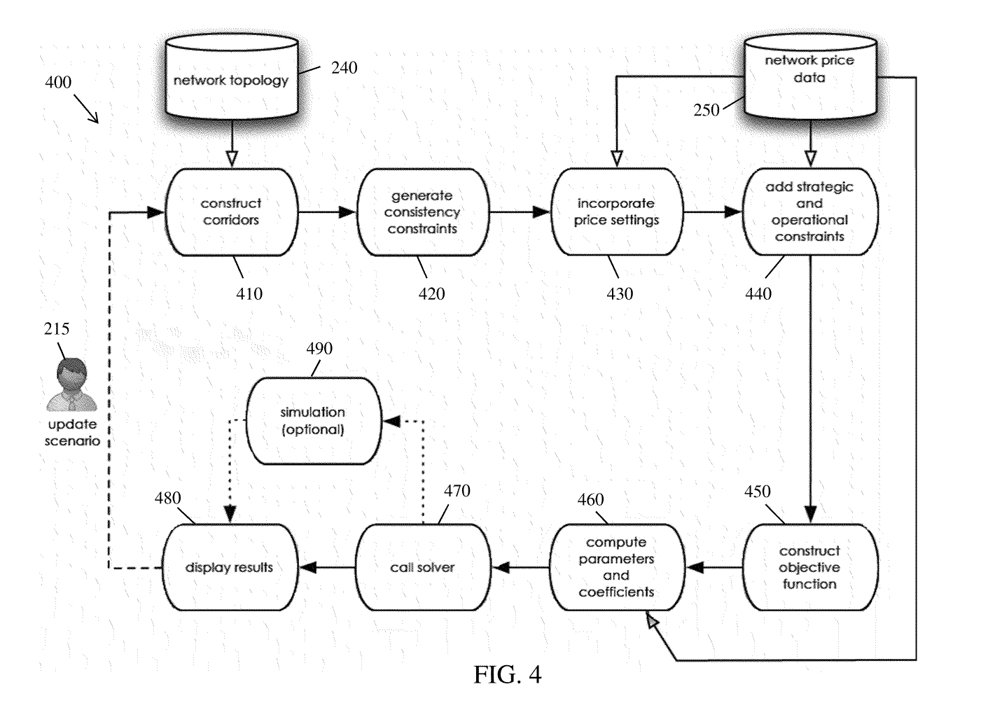

With reference now to FIG. 4, a flow diagram of an operation 400 for consistent price optimization in transportation networks of an embodiment is shown. In block 410, corridors are constructed for each O-D pair. Each corridor is constructed based on an allowed detour ratio and an allowed betweenness ratio. Detour ratio input data and betweenness ratio input data are received from the network topology and corridors database 240.

In block 420, consistency constraints, including monotonicity constraints and triangle constraints, are generated for each corridor in the mathematical optimization problem. Price settings are then incorporated into the mathematical optimization problem in block 430. According to an embodiment, the price elasticity, price and demand database 235 provides input data, such as current demand, current price, elasticity, that may be used to calculate and define the maximum price variation allowed from a goal price set by the revenue manager 215.

In block 440, strategic and operational constraints, such as capacity constraints, are incorporated into the mathematical optimization problem. According to an embodiment, the price elasticity, price and demand database 235 provides input data that may be required to generate the strategic and operational constraints.

In block 450, an objective function is constructed according to an embodiment. The objective function is convexified into a multi-dimensional space using point-price elasticity to capture the global revenue by summing up revenue for each O-D pair. An embodiment then computes the parameters and the coefficients for the mathematical optimization formula as shown in block 460. The computed coefficients include, but are not limited to, a linear price-revenue coefficient (1−eᵢⱼ)Dᵢⱼ^{curr} and a quadratic price-revenue coefficient

$$\frac{{e}_{ij} {D}_{ij}^{curr}}{{P}_{ij}^{curr}} .$$

In block 470, a dedicated solver is called to find a solution to the mathematical optimization problem formed from the objective function and the previously discussed constraints. In block 480, the resulting prices and predicted revenue is displayed to the revenue manager 215. Optionally, a simulation module may be used to compute, for each O-D pair, an abstract model to find an optimal travel option for a large number of travelers and to stochastically simulate the resulting total revenue, as shown in block 490.

An embodiment is convex program implemented by processing unit 16 of computer system 10, which can be efficiently solved to optimality with contemporary optimization solvers. Scenarios that are more complicated than linear price elasticities can be handled in a similar manner according to an embodiment, such as the case when the price elasticity function is piecewise linear but concave.

An automated decision support tool of embodiments of the disclosure efficiently optimizes, simulates, and visualizes consistent pricing schemes, with an interactive dashboard for scenario management, what-if analysis, and control of the revenue management process in the railway, coach, and urban transport segments of the T&T industry. Embodiments simultaneously manage thousands of different fare elements, fare rules, transport service components and constraints, together with the coordination of local and long-distance transport service networks. Further, the computation of embodiments is very fast due to the application of cutting edge optimization techniques and providing online decision support on even large networks with hundreds of nodes. Embodiments also provide consistency of the computed pricing scheme for a considered transportation network, which makes abuse of the fares impossible. Moreover, embodiments handle the whole network in a unified way and can minimize the deviation of the optimized pricing scheme from a predefined goal price, can be used for load balancing by choosing the goal price as the one which has the desired load balancing effect, and can deal with various forms of price elasticity functions. Additionally, exemplary embodiments handle the triangle and overshoot inconsistencies in an efficient way.

Embodiments of the disclosure provide global pricing optimization that enables active price and revenue management, while guaranteeing consistency over all relations. Seamless smarter transportation and multi-modal mobility pricing concepts cannot be implemented if corresponding pricing engines are not available to provide decision support for network operators and passengers alike. The disclosed embodiments provide an answer to this demand.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The disclosed flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A computer-implemented method, comprising:
constructing, with a processing device, a corridor for each origin-destination pair of a transportation network based on one or more parameters;
generating monotonicity constraints and triangle constraints for each origin-destination pair;
constructing an objective function for price optimization;
convexifying the objective function using point-price elasticity;
computing the one or more parameters and coefficients for a mathematical optimization program; and
solving the mathematical optimization program to optimality.

2. The computer-implemented method of claim 1, further comprising generating price variation constraints for each origin-destination pair.

3. The computer-implemented method of claim 1, further comprising generating strategic and operational constraints for each origin-destination pair.

4. The computer-implemented method of claim 1, wherein the one or more parameters comprises an allowed monotone detour limit and an allowed betweenness limit.

5. The computer-implemented method of claim 1, wherein the objective function is defined to find a consistent pricing scheme that maximizes global revenue, minimizes the sum of deviations or the sum of the squares of the deviations between the optimized and goal price, or minimizes the number of origin-destination pairs that differ from the goal price.

6. The computer-implemented method of claim 1, further comprising a simulation module for estimating revenue when a pricing scheme is employed.

7. The computer-implemented method of claim 1, wherein the objective function comprises linear and quadratic price terms.

8-14. (canceled)

15. A computer program product, comprising:
a computer readable storage medium having computer readable program code stored thereon that, when executed, performs a method, the method comprising:
constructing, with a processing device, a corridor for each origin-destination pair of a transportation network based on one or more parameters;
generating monotonicity constraints and triangle constraints for origin-destination pair;
constructing an objective function for consistent price optimization;
convexifying the objective function using point-price elasticity;
computing the one or more parameters and coefficients for the mathematical optimization program; and
solving the mathematical optimization program to optimality.

16. The computer program product of claim 15, further comprising generating price variation constraints for origin-destination pair.

17. The computer program product of claim 15, further comprising generating strategic and operational constraints for origin-destination pair.

18. The computer program product of claim 15, wherein the one or more parameters comprises an allowed monotone detour limit and an allowed betweenness limit.

19. The computer program product of claim 15, wherein the objective function is defined to find a consistent pricing scheme that maximizes global revenue, minimizes the sum of deviations or the sum of the squares of the deviations between the optimized and goal price, or minimizes the number of origin-destination pairs that differ from the goal price.

20. The computer program product of claim 15, further comprising a simulation module for stochastically estimating revenue when a pricing scheme is employed.

21. The computer program product of claim 15, wherein the objective function comprises linear and quadratic price terms.
